(19) United States
(12) Patent Application Publication
(10) Pub. No.: US 2009/0044470 A1
(43) Pub. Date: Feb. 19, 2009

(54) PROFILED WATERTIGHT BUILDING SHEET AND METHOD FOR PRODUCTION OF SAME

(75) Inventor: John Oldroyd Cheetham, Kragero (NO)

Correspondence Address: ROTHWELL, FIGG, ERNST & MANBECK, P.C., 1425 K STREET, N.W., SUITE 800, WASHINGTON, DC, 20005, US

(73) Assignee: OLDROYD SYSTEMER AS, Sannidal (NO)

(21) Appl. No.: 12/281,241

(22) PCT Filed: Feb. 27, 2007
(86) PCT No.: PCT/NO07/00077

§ 371 Date: Aug. 29, 2008

(30) Foreign Application Priority Data
Mar. 1, 2006 (NO) 20061008

(51) Int. Cl. E04C 2/32; B32B 3/30; B32B 3/28; B32B 43/00

(52) U.S. Cl. 52/309.1; 264/109; 264/176.1

(57) ABSTRACT

The invention concerns a profiled building sheet of a type which has at least one side provided with outward facing studs and/or other types of profiles, the said building sheet being intended, amongst other things, to protect a building from the intrusion of water, in that the building sheet includes a layer of material which prevents water from passing through the sheet and into the building. The building sheet consists of at least two layers where at least one of these layers consists of a material which possesses the properties and/or gives the effect(s) it is desired that the building sheet shall have. The invention also concerns a procedure for producing such building sheets.

The present invention relates to a profiled building sheet and/or watertight sheet of a type where at least one side is provided with outward facing studs and/or other types of profiles and where the building sheet is intended for use in connection with building constructions. The invention relates additionally to a method for producing such building sheets. The building sheet is, amongst other things, designed to protect a building from the intrusion of water or dampness in that the sheet comprises a layer of a material which prevents water or dampness to pass through the sheet. The building sheet is of a type which, at least on the one side is equipped with studs, grooves or similar outward facing protrusions.

From EP 0 284 714 a composite sheet formed of two plastic layers fastened to each side of a fiber mat is already known. The two layers consist of polythene (PE) on the one side and polyamide (PA) on the other. The mat consists of a mixture of PE and PA fibers. During production of the composite sheet it is important that the fibers in the middle sheet partly penetrate both outside layers of PE and PA respectively.

There are waterproof membranes on the market of the above type which are made either of virgin material or from recycled raw materials. Sheets made from recycled material are considerably cheaper than waterproof membranes made from virgin materials. The market share of these cheaper sheets is increasing particularly in the private building sector where price is often more decisive than quality and durability. The recycled raw materials used are first roughly sorted and thereafter made into pellets. Recycled plastic pellets perform like ordinary raw materials except for a reduction in the mechanical properties of the product. Waterproof membranes made from recycled plastic have a characteristic appearance with, amongst other things, a partly matt and rough surface and an unpleasant smell. Additionally the mechanical properties are poorer than those of membranes made from virgin materials specially suited for waterproof membranes.

One of the problems associated with the use of recycled plastic is that it is not possible, with a sufficient degree of certainty, to know of what the recycled material consists. For this reason it is neither possible, with a sufficient degree of certainty, to give a product guarantee nor to predict the properties of the produced membrane since there are normally varying amounts of other types of plastic materials present than those presumed to be in the recycled material. The amount, properties and quality of the recycled material will also be unknown. All these factors increase the likelihood of problems in obtaining sufficient adhesion between the layers during production. This is of particular importance if the membrane to be produced is formed from several layers in a co-extrusion process. The reason for this is that when different co-polymers are mixed together there can be weak links and therefore poor adhesion between the layers.

A further problem is that the suppliers of the different types of extrusion equipment including equipment for the co-extrusion of membranes of this type are unwilling to guarantee the equipment's output.

One object of the present invension is to produce waterproof membranes of high quality and with the necessary and desired vapour barrier, insulation and strength properties coupled with ease of installation and low production costs.

Membranes according to the invention are of the so called sandwich type. They comprise an inner layer of recycled plastic material together with at least one layer of virgin material on each side of the centre core, this minimum of three layers being formed by co-extrusion.

According to the preferred embodiment of the invention the middle layer of recycled granulated plastic is fed to the extruder without first being processed to pellets. In such a layered construction, with virgin plastic material forming the outer visible surfaces, a water tight membrane with an agreeable appearance is achieved without the characteristic smell often associated with membranes produced from recycled plastic material. It should be emphasized in this connection that the membrane will remain watertight even if a hole should form in the inner layer since the two outside layers of virgin material will remain watertight.

The two outer layers of virgin plastic material will, in addition, contribute to an increase in the mechanical strength whilst the consumption of these more expensive virgin materials is reduced.

According to another preferred embodiment the core or inner layer is formed from an expanded material so that the sheet assumes insulating properties in addition to being watertight.

The objects of the invention are achieved by a building sheet and a procedure more closely described in the independent patent claims.

Different embodiments of the invention are more closely described in the dependent claims.

According to the invention the building sheet is formed of at least two layers where at least one of the layers is formed from a material which has or gives the characteristics desired in the building sheet.

At least one layer with the desired characteristics can be formed of an expanded material and/or a rubberized or rubbery material, for example TPE, TPO or TPU. In the following such materials will only be referred to as a rubber like layer.

This layer can with advantage be co-extruded with the other layers. In addition a non-extruded layer can be laid on the sheet with the desired characteristics.

A rubber like layer may preferably be such that the friction between a mass resting on this rubber like surface and the rubber like surface itself and/or the rubber like surface against the underlay is sufficient to hinder sliding.

Furthermore, a water permeable material can be co-extruded on at least one side of the building sheet. According to the invention it is also possible for at least one of the co-extruded layers to be formed from recycled material in that this material is in the form of a granulated, non-pelletized raw material intended for being fed directly into the extruder.

According to another embodiment of the invention one of the layers may comprise a mixture of wood fiber and a plastic material, either virgin or recycled plastic, a so called WPC material. Mixing wood fiber into such a plastic material will give increased strength, stiffness and reduced costs. The size of the wood fibers is dependent on which properties are desired in the final product.

The fibers can also be those from ground up reinforced hard plastic such as that from plastic boat hulls and the like.

In a further embodiment of the invention the wood fibers may be replaced by paper, carton and/or pulp/cellulose, that is to say, a so called PPC material.

The material chosen to form the inner layer can with advantage be recycled plastic in a ground up non-pelletized form.

According to another production method, virgin material, with or without additives, can be used to form the outside layer of the building sheet. The material intended for the inner layer is fed from the extruder to the co-extruding tool and from there to the inner layer so that at least three co-extruded layers come out of the co-extruding tool with the material for the inner layer sandwiched between two layers of virgin plastic material. Alternatively the building sheet can have two layers where one of these is the virgin material whilst the other consists of one of the alternative materials already mentioned above.

The material which is to form the middle layer can be strained and/or washed in an automatic washer and/or strainer system which removes dirt and foreign matter prior to feeding to the extruder.

The middle layer may for example be made of an expanded material where the expansion takes place in immediate connection with the co-extruding process.

At least one of the outside layers can have rubber like characteristics.

The plastic material which is to form the outside layers is run through the extruder in the same way as the recycled plastic.

During production the plastic material for the outside layers and the cleaned recycled material are fed to the co-extrusion block in which the two streams of material are converted to three layers which are then extruded as a sheet which can, for example be vacuum formed to a watertight sheet with the desired profile. Such profiles may be studs, rifles or other suitable profiles.

The recycled material is cleaned in the dry state in a dry cleaning unit in order to remove different types of foreign matter, such as fibers from paper and the like. This is done because such fibers frequently block the straining system incorporated in the process and because such fibrous material reduces production efficiency which can be expressed as the number of kilos the extruder can produce per unit of time. The straining or filtering system removes other undesirable contamination and is designed to have sufficient capacity so as not to be a bottleneck in the process and to allow production capacity to be maintained. It should be mentioned that the straining system can give fluctuations in the material stream. By combining these two cleaning methods it will be possible to achieve a stabile material stream in the process so that the end product has the desired quality.

The virgin material which is to form the two outside layers of the product is also fed through one or several extruders in the same way as the recycled material. The plastic material for the outer layers and the recycled material are all fed into the co-extrusion head or block in which these two streams of material are converted to three layers which are then extruded as an integral monolithic sheet which can be vacuum formed to a watertight membrane with studs or grooves.

Not only is the recycled material cheaper it also satisfies the wish to use this resource for environmental reasons.

The sheet can be supplied in rolls or stacked as more or less stiff boards of a handy and economic size for transport.

A preferred embodiment of the invention will be now be described more closely with reference to the figures where:

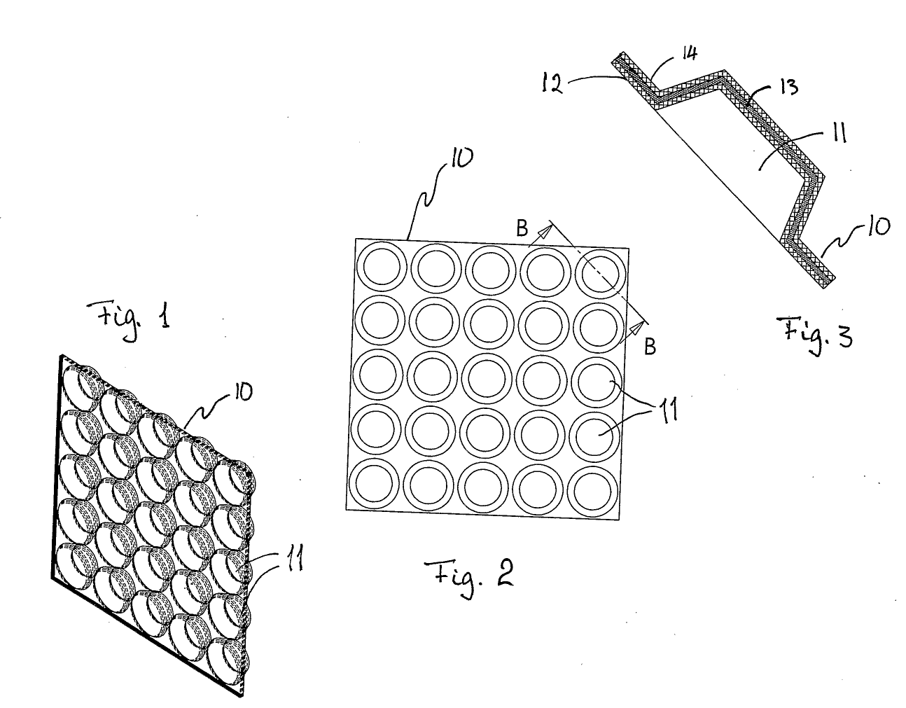

FIG. 1 shows schematically a waterproof membrane according to the invention, viewed in perspective;

FIG. 2 shows the same membrane as in FIG. 1, seen from above;

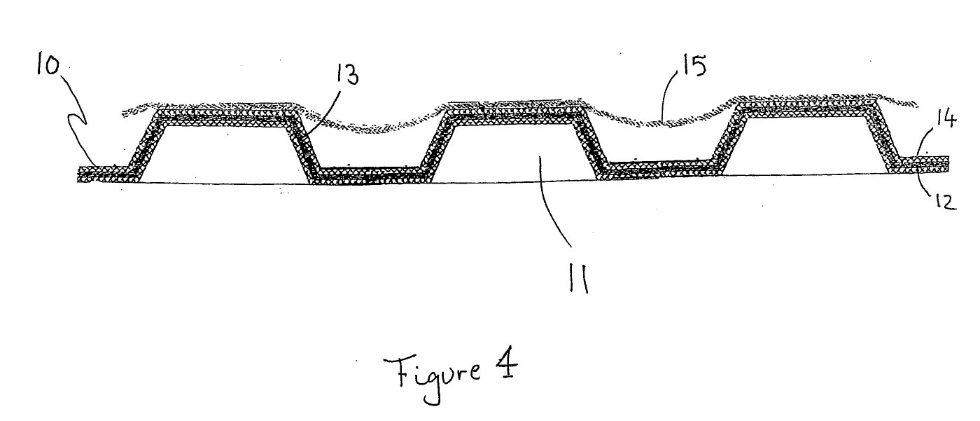

FIG. 3 shows a vertical section through the membrane shown in FIG. 2 viewed along line B-B in FIG. 2; and

FIG. 4 shows a vertical section through an alternative embodiment of the invention where one side of the sheet is equipped with a filter cloth.

FIG. 1 shows schematically a section of a part of a building sheet 10 according to the invention. As indicated in the Figure the building sheet 10 is formed with a number of studs 11 which stand out from one side of the building sheet 10. Even if the Figure shows the use of studs 11, it should be noted that these can be replaced by other types of profiles without the building sheet deviating from the inventive idea of the invention.

FIG. 2 shows the same section seen from above of a part of the building sheet 10 shown in perspective in FIG. 1.

FIG. 3 shows a vertical section through the building sheet 10 shown in FIG. 2, viewed along the line B-B. This section is through one of the studs 11. As indicated on the Figure this is an example of a building sheet 10 formed from three layers 12, 13, 14, where the number 12 and 14 represent the outer layers and number 13 represents the middle layer.

In accordance with the embodiment shown the studs are convex on the one side of the building sheet 10 whilst stud 11 is concave on the other side. In a case where, for example, grooves are used which project from the building sheet, the other side of the building sheet 10 can either be flat or have correspondingly concave grooves.

According to the invention material is chosen for the different layers in building sheet 10 depending on which properties are desired. The studded sheet must have sufficient stiffness in itself so that the studs do not collapse under pressure from surrounding ground. In such a case material must be used which will give sufficient strength in at least one of the layers 12, 13, 14. At the same time it is important that the sheets 10 do not become so stiff that they will no longer follow the contours of the building construction to be protected.

If a surface which increases friction is desired as is the case when a building sheet 10 is to be used as an underlay for turfed roofs it is necessary to use a material or additive which increases the surface friction against the turf. In such a case the layers 12 and/or 14 can be made of a rubber like material.

In most cases there is a need for the building sheet 10 to be watertight. In such a case materials are chosen which have watertight properties for at least one of the layers 12, 13, or 14.

Where there is a need for the building sheet 10 to have insulating properties a porous material preferably with closed cells is used. This material can preferably be placed in the middle layer 13. If the insulating layer has a closed cell construction it can be placed as an outside layer 12 or 14.

Further it should be noted that if there is a need for a building sheet 10 with several of these properties different materials also having different properties can be used for the different layers 12,13,14 depending on the final properties desired.

Even if it is indicated above that the outside layers 12 and 14 are made of virgin material the inner layer 13 can be of recycled or expandable material it should be noted that virgin material can be used for two adjacent layers.

Further, it should be noted that even if a three layer building sheet has hitherto been described the number of layers can be varied without deviating from the main idea behind the invention.

Even if the sheet according to the invention has been described in connection with a waterproof foundation membrane or an underlay for a turfed roof it should be noted that the sheet can also form a water permeable layer in connection with outdoor or indoor paddocks for horses or as an underlay for sports arenas such as football fields or golf course greens where the sheet is laid on the ground and covered with a more or less thick layer of sand or similar material. Such an alternative is shown in FIG. 4 which shows a section through a sheet 10 equipped with studs 11. As is shown in the Figure the filter cloth 15 is laid on the stud side of the sheet 10. With such an application water will filter through the cloth 15 and be drained away along the surface of the sheet 10. The sheet 10 for this purpose is laid with a slight inclination away from the arena in question. The sheet is further calculated to be laid with the studs upwards. In this way a more or less spring underlay is established created by the upward facing studs which will be pressed down by point loading and thereafter recover when the load is removed. The edges round the studs will in this case function as ‘hinges’. Furthermore the sheets can preferably on the side intended to face downwards, have grooves or profiles to avoid the sheet slipping on the substrate.

It can further be mentioned that the sheets can also be equipped with a filter cloth which allows water to pass through but which hinders the passage of fine particles, silt and other solids to pass through so that drainage is established.

1.-16. (canceled)

17. Profiled building sheet of a type which, on at least one side, has outward facing studs and/or other types of profiles, said building sheet, amongst other things, is intended to protect a building against the intrusion of water and intended to follow the contours of the building structure to be protected, said building sheet comprises a layer of a material which hinders water from passing through the sheet and into the building, and further comprises at least two layers of separate material, characterized in that at least one of these layers is formed from a rubber like material and/or made of a mixture of wood fibers and plastic materials, at least one other layer being made of virgin plastic materials and/or recycled plastic materials, the layers being formed by co-extrusion and subsequently vacuum formed, giving the building sheet its profiled surface which has the properties and/or gives the effect(s) desired of the building sheet.

18. Profiled building sheet according to claim 17, where a layer with the desired properties is formed of an expanded material.

19. Profiled building sheet according to claim 17, where a layer with the desired properties is formed of a rubber like layer.

20. Profiled building sheet according to claim 18, where a layer of a material with the desired properties is co-extruded with the other layers.

21. Profiled building sheet according to claim 18, where the layer of a material with the desired properties is applied as a non co-extruded layer.

22. Profiled building sheet according to claim 19, where the rubber like layer is such that the friction between it and material resting upon it or between it and the material it is resting upon is sufficient to hinder sliding.

23. Profiled building sheet according to claim 17, where a layer of water permeable material is co-extruded on at least one side of the building sheet.

24. Profiled building sheet according to claim 17, where one of the co-extruded layers is formed of recycled plastic material, which material being in the form of granulated non-pelletized raw material, fed directly into the extruder.

25. Profiled building sheet according to claim 17, where one of the layers is made of a mixture of plastic material and wood fiber.

26. Profiled building sheet according to claim 17, where one of the layers is made of a mixture of plastic and paper, carton and/or pulp/cellulose.

27. Method for the production of a building sheet described in claim 17, where virgin plastic material with or without additives is intended to form at least one outside layer of the building sheet and where the material intended to form at least one other layer is fed from the extruder to a co-extruding tool and further to the already mentioned other layer, so that from the co-extruding tool at least two layers are formed with material for the other layer lying on one side of the of at least one layer of virgin plastic material.

28. Method according to claim 27 where the aforementioned layer of virgin plastic is made up of two layers and where the other layer forms the middle layer between the two layers of virgin material.

29. Method according to claim 28, where the material intended for the middle layer consists of recycled plastic in a granulated, non-pelletized form.

30. Method according to claim 27, where the material intended for the middle layer is sieved and/or washed or dry cleaned in a unit which removes dirt and foreign matter before the material is fed to the extruder.

31. Method according to claim 27, where the layer is made of an expanded material, the expansion taking place in close connection with the extrusion process.

32. Method according to claim 27, where at least one of the outside layers is of a rubber like character.
